(19) United States
(12) Patent Application Publication
(10) Pub. No.: US 2003/0163991 A1
(43) Pub. Date: Sep. 4, 2003

(54) RAKH CYCLE - thermodynamic cycle

(76) Inventor: Robert Hurt, San Diego, CA (US)

Correspondence Address: Robert David Hurt, 10030 Tree Haven Ct., San Diego, CA, 92131, US

(21) Appl. No.: 10/090,433

(22) Filed: Mar. 5, 2002

Related U.S. Application Data
(60) Provisional application No. 60/268,035, filed on Feb. 12, 2001.

(51) Int. Cl. F01B 1/00; F01K 1/00; F02B 1/00; F01B 29/00; F01P 1/00

(52) U.S. Cl. 60/670; 60/508; 60/512; 60/514; 60/515

(57) ABSTRACT

A thermodynamic cycle consisting of six events repeated continuously. Event 1 is adiabatic compression of a carrier gas to raise its temperature. Event 2 is liquid Injection into the hot carrier gas near the end of event 1. Event 3 is temperature equalization between the carrier gas and injected liquid with the liquid's full or partial vaporization. Event 4 is adiabatic expansion of the mixture. Event 5 exhausts the mixture. Exhaust should be captured to save and separate the mixture into its components to increase efficiency, however, this cycle may be either an open or closed cycle. Event 6 is the induction a new charge of carrier gas, which brings the cycle back to the initial conditions of event one. This cyclical sequence of six events numbered from any starting point will be referred to as the RAKH CYCLE. Engines using it are RAKH engines. Refrigeration machines using it are RAKH refrigerators.

### BACKGROUND OF INVENTION

In researching the present invention, I discovered many patents that took advantage of waste heat to increase mechanical work and engine efficiency. Most of these patents selected water as the injected liquid. None of the other patents, however, made use of superheated injected liquids. Typically, ambient water was converted to steam using waste heat of combustion gasses. Each also used internal combustion from an Otto or Diesel cycle to generate the heat. The present invention does not use internal combustion for its heat source. A ‘carrier gas’ is heated outside the engine, via exhaust recovery heat, solar, or some other method. A liquid is also pre-heated externally or by purchasing (or renting) an insulated, pressurized container of the hot liquid.

### References Cited

### U.S. Patent Documents

| | | | |
|---|---|---|---|
| 770468 | Sep., 1904 | Lake | 60/674 |
| 917317 | Apr., 1909 | Lake | 60/674 |
| 924100 | Jun., 1909 | Nichols | 123/191 |
| 1032236 | Jul., 1912 | Pattern | 60/650 |
| 1739255 | Dec., 1929 | Niven | 123/193 |
| 1926463 | Sep., 1933 | Stoddard | 60/650 |
| 2062013 | Nov., 1936 | Opolo | 123/193 |
| 3006146 | Oct., 1961 | Jackson | 60/649 |
| 3867816 | Feb., 1975 | Barrett | 60/682 |
| 3,964,263 | Jun. 22, 1976 | Tibbs | 60/712 |
| 4,270,351 | Jun. 2, 1981 | Kuhns | 60/517 |
| 4,322,950 | Apr. 6, 1982 | Jepsen | 60/712 |
| 4,326,388 | Apr. 27, 1982 | McFee | 62/324.6 |
| 4,402,193 | Sep. 6, 1983 | McFee | 62/304 |
| 4,553,397 | Nov. 19, 1985 | Wilensky | 60/649 |
| 4,691,523 | Sep. 8, 1987 | Rosado | 60/649 |
| 5,035,115 | Jul. 30, 1991 | Ptasinski | 60/712 |
| 5,983,640 | Nov. 16, 1999 | Czaja | 60/674 |

### DETAILED DESCRIPTION

The thermodynamic cycle, which is described herein will be called the RAKH CYCLE in respect for all the support I got from my wife, Kay. The said RAKH CYCLE involves a gas or mixture of gasses that are herein referred to as the ‘carrier gas’ and a superheated liquid which vaporizes but does not burn. The purpose of the carrier gas is to bring thermal energy into a volume whereby compression concentrates the thermal energy at a higher temperature. A liquid is then injected. In an engine cycle, the liquid must be superheated above its saturation temperature for the pressure to which the carrier gas will attain at its state of maximum compression. The carrier gas must be much hotter than the injected liquid in order to force heat to be transferred into the injected liquid rapidly. Heat that is transferred from the carrier gas will cool the carrier gas resulting in a lower temperature and pressure. Transfer of the heat from the carrier gas into the liquid, on the other hand, will greatly increase the volume of the injected liquid, through converting it into a vapor. The temperature of the liquid will increase while the temperature of the carrier gas will decrease. The decrease of temperature is offset to a higher value by further compression of the carrier gas due to the vapor produced, which displaces the carrier gas into a smaller volume to accommodate the vapor. All experimental results, which I have derived by calculation, have always resulted in a lower temperature from the end of event one to the end of mixture temperature equalization for event three. This may not be true for real liquids that are injected at pressures above their critical point into a carrier gas that is compressed to a point that is above the critical pressure of the liquid. Some real gasses and liquids exhibit an overall increase in pressure upon vaporization of the liquid in the mixture. The compression phase end temperature of the carrier gas before liquid injection decreases after temperature equalization of the mixture. The present invention covers substances injected above their critical temperature and pressure. These superheated substances are not usually still considered to be liquids. The best choice of carrier gas would not condense at the end pressure. The purpose of the carrier gas is to carry heat into the cycle, which is transferred to a liquid injected at a later point in the cycle after the carrier gas is compressed. Calculations are very difficult because of changing gamma values for the liquid and carrier gas. The preferred implementation uses Argon as the carrier gas and water as the injected liquid. The gamma value for Argon is virtually constant at varying temperatures. The gamma value for H2O at various saturation temperatures is shown in FIG. 1.

The first event of the RAKH CYCLE is compression of a carrier gas to a maximum compression point with heat added or through strict adiabatic compression. The purpose of this compression is to concentrate the thermal heat via an increase in temperature to force rapid transfer of energy to the liquid injected in event two.

The second event in this thermodynamic cycle is the injection of liquid into a very nearly constant volume of the gas at the end of the first event. If the cycle is used in an engine, the liquid will be heated to some temperature such that part of the liquid flashes into a gas due to the excess thermal energy of the liquid beyond that of the liquid at its saturation temperature for the pressure in the cylinder (or turbine) arrived at by the mixture.

Event three in the cycle is equalization of temperature prior to the rapid expansion event, which follows. This third event then includes the transfer of thermal energy from the carrier gas to the injected liquid, which had not yet completely flashed to a gas. If there is a sufficient temperature difference to allow heat to transfer from the carrier gas to the liquid at its saturation temperature and pressure, further vaporization will occur. Complete vaporization is not required for this event. The mixture's pressure may go down during this event. Pressure and or the temperature may be above the critical point for the liquid at the point of injection or after the temperature equalization of event three. In an engine, pressure must increase from that at the end of event 1.

The fourth event is adiabatic expansion of the mixture. This expansion will likely be back down to the original volume found at the beginning of event one, but may be somewhat more or less. This is where a turbine engine application may have the advantage over a piston engine since the final volume of a piston engine is geometrically constrained to equal event one starting volume. It is very hard to calculate mixture pressure and temperature during expansion so values at each point of expansion were calculated as if the liquid were injected at that point during compression.

The fifth event is the exhausting of the mixture. The exhaust mixture should be captured into a condenser designed to handle separation of the mixture into its separate components to increase efficiency. This invention, however, does not require a condenser, but does assume a continuous supply of carrier gas and liquid from some source at a constant temperature and pressure.

Event six is the induction of the carrier gas, which brings the cycle back to the initial conditions of event one whenever the cycle is running in a steady state. This sequence of six events will be repeated as a continuous thermodynamic cycle, which will be referred to as the RAKH CYCLE regardless of the starting point picked for event 1.

Engines that use this cycle are RAKH engines. Refrigeration machines that use this cycle with appropriate working substances selected for refrigeration are referred to as RAKH refrigerators.

The selection of the carrier gas and liquid are major impact variables in the cycle efficiencies. The ability of the combination to produce power is a very narrow margin between operable and non-operability of the cycle. The variability of gamma for the real gasses is what allows the cycle to work below the critical point. The gamma value is the ratio of the specific heat at constant pressure to the specific heat at constant volume. For a small adiabatic change of volume, the change of pressure is dependent upon gamma in the relationship: P2=P1 times (V1/V2) raised to the gamma power where P1 is the starting pressure, V1 is the starting Volume, and V2 is the final volume. If gamma is 2 and the compression ratio is 10 then the adiabatic final pressure will be P1 times 100 (10 squared) and not just P1 times 10 as might be expected. The reason for the unexpected increase of pressure is that temperature goes up quickly and raises the pressure even more than would otherwise be expected.

### FIGURES AND ILLUSTRATIONS

FIG. 1 shows the tremendous change in gamma with respect to the starting temperatures for water injected at various superheated temperatures. Using some wider range standardized thermodynamic data tables or empirical data from actual experimentation beyond the critical point of water may reveal an even more efficient engine, operating in an injection temperature range above the data range used for calculations herein. The greater the pressure increase caused by events 2 and 3 in the RAKH Cycle, the more power the engine can develop.

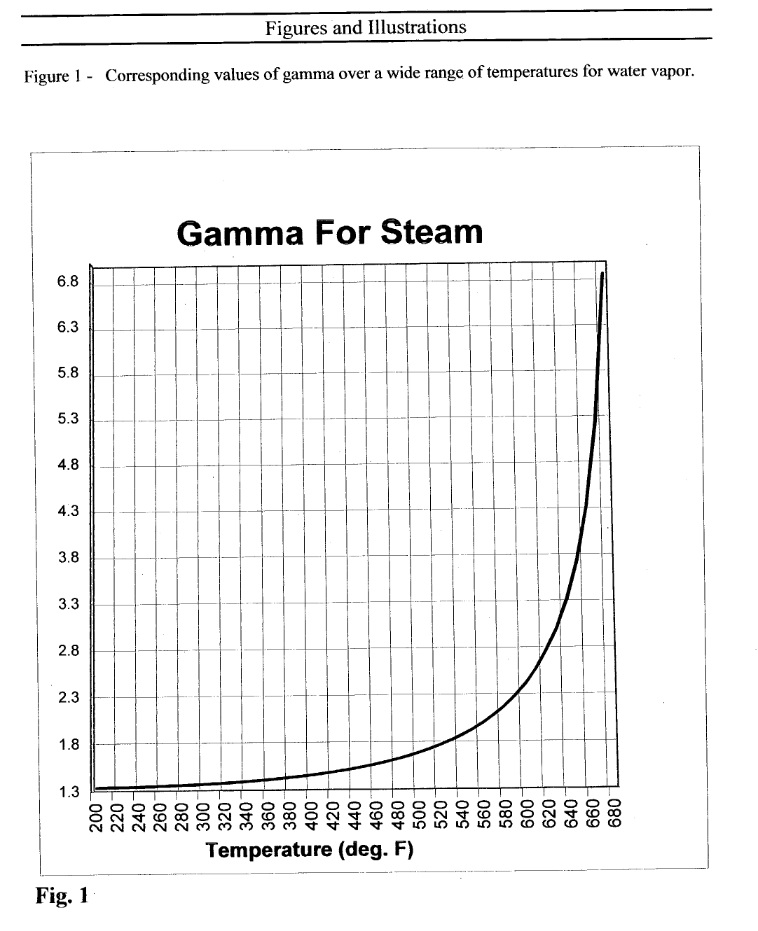

FIG. 2 shows that calculated engine efficiency increases directly proportional to the injection temperature. Minimizing the necessity for adding latent heat tends to increase RAKH Cycle engine efficiency by preserving the temperature of the carrier gas. Considered separately, the absolute pressure of the carrier gas is directly proportional to its absolute temperature at a constant volume. FIG. 2 uses the preferred carrier gas of Argon and water injected at various superheated temperatures. Some further experimentation or theoretical extrapolations of temperatures beyond the critical point may yield a still more efficient yet practical engine. The increase of pressure caused by RAKH Cycle events 2 and 3 can be increased by minimizing the necessity for adding latent heat. Supplying the latent heat, robs the carrier gas of its heat in the form of a lowered temperature. Thus its pressure will decrease too, which reduces the power.

FIG. 3 shows power and efficiency versus the quantity of water injected at two different initial carrier gas temperatures, the higher the better. Too much water chokes the power and efficiency.

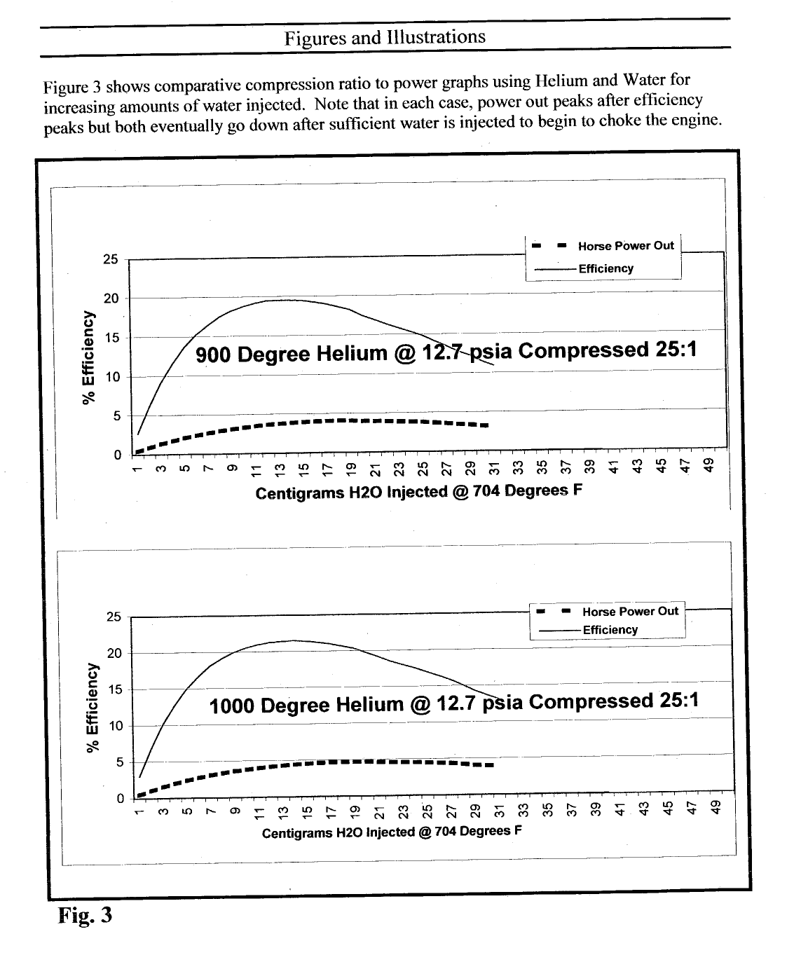

FIG. 4 graphs various compression ratios per a highly iterative computer program simulation of a piston engine compression and power strokes.

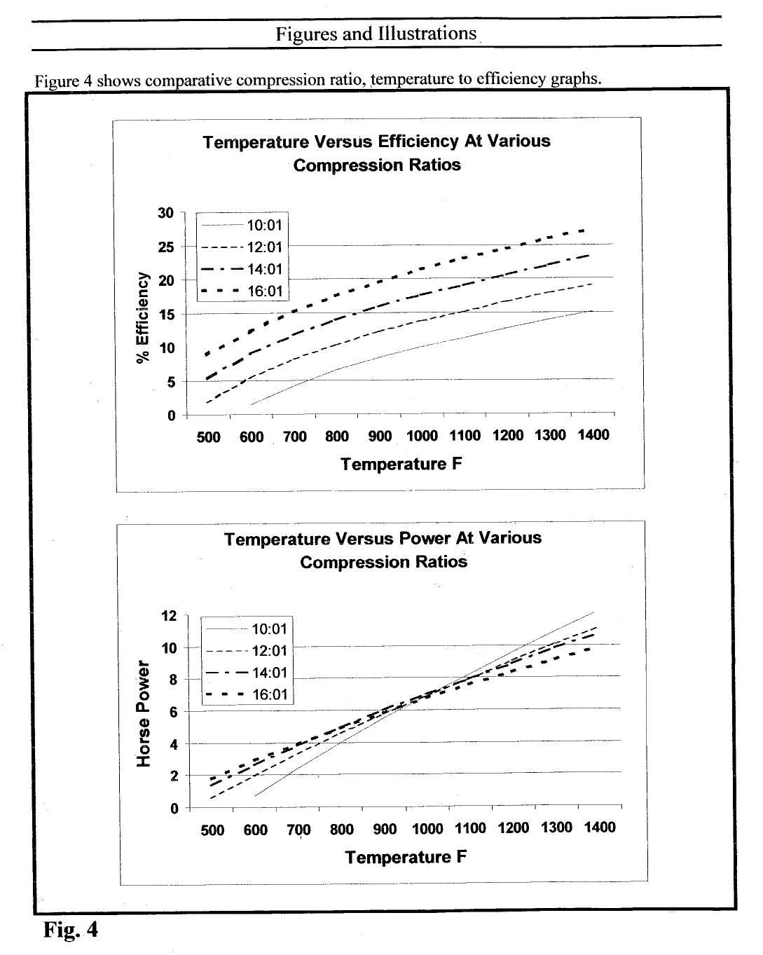

Listings 1 through 6 are computer calculated simulation printouts for various compression ratios, carrier gas initial temperatures, and pressures, with optimized water injection masses. Gamma values were changed in the program at frequent intervals for the injected water. The program calculated temperature and pressure of the expanding mix for each two degrees of crank rotation. Listings show efficiency increases when compression ratios or temperatures are increased.

Figures and Illustrations

Listing 1 is a computer printout for 8:1 compression at 1200 deg. F. starting gas temperature.

Argon @ STP=39.948 grams for 22.4 liters

Cp=0.133; Cv=0.075165; gamma=1.769441

T2=7760.784 deg. F. & P2=2813.341 psia; Head Vol.=62.5 cc; CR=8:1; free Ambient=300 deg. F.

Argon Pres/Temp compensated mass in grams=1.37449

Thermal energy per power cycle to heat Argon=0.2049907 BTUs

Assumed free feed Water heat=268 BTUs per pound

Thermal energy per power cycle to heat Water=7.598673E-02 BTUs

Mechanical work done to compress the Argon is −928.0307 ft-lbs

Event 2

At TDC, inject 0.06 grams of superheated Water at 704 deg. F. % Mole mass Argon=95.81733% %Mole mass H2O=4.18267%

Since the injected Water is superheated, some flashes to vapor;

Volume .06 grams of Saturated vapor at 2784.7 psia=0.390925 cc So, Argon is further compressed and now occupies only 62.10907 cc

The cylinder pressure however, decreases to 2784.7 psia as a result of all the Water converting to saturated vapor and the carrier gas temperature changes to 7638.407 Equalizing temperatures, the vapor's temperature goes up to meet Argon's decreasing temperature at 5692.219 deg. F.

8:1 Compression of Argon starting @ 1200 deg. F. & 71 psia

Calculating partial volumes of 0.06 grams Water vapor & 1.37449 grams Argon yields 4.551353 & 57.94865 cc respectively after equalizing temperatures.

Sums of the partial volumes must equal the cylinder volume of 62.5 at TDC.

| Angle | Temp. F | PSIA | Cyl Vol | Steam | Argon |
|---|---|---|---|---|---|
| 90 | 5692.219 | 2983.976 | 62.5 | 4.5513 SUP | 57.94865 |
| 80 | 5415.021 | 2657.699 | 66.60092 | 4.9205 SUP | 61.68034 |
| 70 | 4747.316 | 1959.702 | 78.80437 | 5.9693 SUP | 72.83501 |
| 60 | 3973.675 | 1307.761 | 98.53674 | 7.6205 SUP | 90.91614 |
| 50 | 3265.964 | 851.2669 | 124.8817 | 9.8463 SUP | 115.0354 |
| 40 | 2691.061 | 564.1493 | 156.6411 | 12.607 SUP | 144.0338 |
| 30 | 2241.762 | 387.6474 | 192.4153 | 15.710 SUP | 176.7049 |
| 20 | 1897.452 | 278.4525 | 230.6973 | 19.435 SUP | 211.2621 |
| 10 | 1624.841 | 208.0506 | 269.9732 | 22.626 SUP | 247.347 |
| 0 | 1416.888 | 163.8102 | 308.8161 | 28.522 SUP | 280.2934 |
| −10 | 1254.789 | 132.4055 | 345.9635 | 32.056 SUP | 313.9067 |
| −20 | 1131.672 | 110.5387 | 380.3672 | 33.588 SUP | 346.7791 |
| −30 | 1035.548 | 93.85143 | 411.2137 | 31.029 SUP | 380.1843 |
| −40 | 963.3055 | 82.05675 | 437.9155 | 25.810 SUP | 412.1045 |
| −50 | 908.7077 | 74.63467 | 460.0805 | 22.649 SUP | 437.4312 |
| −60 | 868.5814 | 69.51414 | 477.4703 | 20.515 SUP | 456.955 |
| −70 | 841.2895 | 66.18478 | 489.955 | 19.153 SUP | 470.801 |
| −80 | 827.2404 | 64.29819 | 497.4729 | 18.418 SUP | 479.0547 |
| −90 | 820.8011 | 63.6814 | 499.9999 | 18.153 SUP | 481.8467 |

Exhaust pressure of the binary mixture is 63.6814 psia at 820.8011 degrees F.
Work done is 947.6757 ft-lbs; Estimated W-9 Horsepower @ 3600 RPM = 9.644 hp
Estimated heat for Argon = 55.3475 BTU/sec and for liquid = 20.51642 BTU/sec
Theoretical Efficiency = 8.983552%

Figures and Illustrations

Listing 2 is a computer printout for 8:1 compression at 1400 deg. F. starting gas temperature.

Argon @ STP=39.948 grams for 22.4 liters

Cp=133; Cv=0.075165; gamma=1.769441

T2=8751.396 deg. F. & P2=2813.341 psia; Head Vol.=62.5 cc; CR=8:1; free Ambient=300 deg. F.

Argon Pres/Temp compensated mass in grams=1.22667

Thermal energy per power cycle to heat Argon 0.2235992 BTUs

Free feed Water heat=268 BTUs per pound

Thermal energy per power cycle to heat Water=7.598673E-02 BTUs

Mechanical work done to compress the Argon is −928.0307 ft-lbs

Event 2

At TDC, inject 0.06 grams of superheated Water at 704 deg. F. % Mole mass Argon 95.3368% % Mole mass H2O=4.663202%

Since the injected Water is superheated, some flashes to vapor;

Volume 0.06 grams of Saturated vapor at 2784.7 psia=0.3909251cc So, Argon is further compressed and now occupies only 62.10907 cc

The cylinder pressure however, decreases to 2784.7 psia as a result of all the Water converting to saturated vapor and the carrier gas temperature changes to 8614.273 Equalizing temperatures, the vapor's temperature goes up to meet Argon's decreasing temperature at 6153.344 deg. F.

8:1 Compression of Argon starting @ 1400 deg. F. & 71 psia

Calculating partial volumes of 0.06 grams Water vapor & 1.22667 grams Argon yields 4.858467 & 57.64153 cc respectively after equalizing temperatures.

Sums of the partial volumes must equal the cylinder volume of 62.5 at TDC.

| Crank | | | | | |
|---|---|---|---|---|---|
| Angle | Temp. F | PSIA | Cyl Vol | Steam | Argon |
| 90 | 6153.344 | 2999.854 | 62.5 | 4.8584 SUP | 57.64153 |
| 80 | 5862.012 | 2672.399 | 66.60092 | 5.2606 SUP | 61.34026 |
| 70 | 5153.316 | 1971.232 | 78.80437 | 6.3964 SUP | 72.40793 |
| 60 | 4326.985 | 1315.87 | 98.53674 | 8.1837 SUP | 90.35295 |
| 50 | 3575.412 | 856.8443 | 124.8817 | 10.600 SUP | 114.2809 |
| 40 | 2964.404 | 568.0646 | 156.6411 | 13.612 SUP | 143.0291 |
| 30 | 2475.762 | 390.3107 | 192.4153 | 16.938 SUP | 175.4763 |
| 20 | 2105.5 | 280.4383 | 230.6973 | 20.979 SUP | 209.7177 |
| 10 | 1816.841 | 209.6149 | 269.9732 | 24.602 SUP | 245.3707 |
| 0 | 1590.476 | 165.1332 | 308.8161 | 30.892 SUP | 277.9238 |
| −10 | 1414.789 | 133.8045 | 345.9635 | 34.761 SUP | 311.2022 |
| −20 | 1279.843 | 111.3988 | 380.3672 | 36.596 SUP | 343.7709 |
| −30 | 1175.548 | 94.80654 | 411.2137 | 34.345 SUP | 376.8687 |
| −40 | 1095.426 | 82.59328 | 437.9155 | 28.434 SUP | 409.4808 |
| −50 | 1035.117 | 74.75674 | 460.0805 | 24.783 SUP | 435.2975 |
| −60 | 992.4648 | 69.61333 | 477.4703 | 22.471 SUP | 454.9989 |
| −70 | 962.9454 | 66.27042 | 489.955 | 20.988 SUP | 468.9663 |
| −80 | 945.4143 | 64.37533 | 497.4729 | 20.152 SUP | 477.3203 |
| −90 | 938.8011 | 63.75652 | 499.9999 | 19.869 SUP | 480.1304 |

Exhaust pressure of the binary mixture is 63.75652 psia at 938.801 degrees F.
Work done is 953.8967 ft-lbs; Estimated W-9 Horsepower @ 3600 RPM = 12.697 hp
Estimated heat for Argon = 60.37178 BTU/sec and for liquid = 20.51642 BTU/sec
Theoretical Efficiency = 11.09368%

Figures and Illustrations

Listing 3 is a computer printout for 10:1 compression at 1200 deg. F. starting gas temperature.

Argon @ STP=39.948 grams for 22.4 liters

Cp=0.133 Cv=0.075165 gamma=1.769441

T2=9300.61 deg. F. & P2=2764.002 psia; Head Vol.=50 cc; CR =10:1;

free Ambient=300 deg. F.

Argon Pres/Temp compensated mass in grams=0.9098739

Thermal energy per power cycle to heat Argon=0.1356981 BTUs

Free feed Water heat=268 BTUs per pound

Thermal energy per power cycle to heat Water=6.332228E-02 BTUs

Mechanical work done to compress the Argon is −758.6626 ft-lbs

Event 2

At ADC, inject 0.05 grams of superheated Water at 704 deg. F. % Mole mass Argon=94.79099% % Mole mass H2O=5.209018%

Since the injected Water is superheated, some flashes to vapor;

Volume 0.05 grams of Saturated vapor at 2732.787 psia=0.3402922cc

So, Argon is further compressed and now occupies only 49.65971 cc

The cylinder pressure however, decreases to 2732.787 psia as a result of all the Water converting to saturated vapor and the carrier gas temperature changes to 9141.189 Equalizing temperatures, the vapor's temperature goes up to meet Argon's decreasing temperature at 6281.403 deg. F.

10:1 Compression of Argon starting @ 1200 deg. F. & 47 psia Calculating partial volumes of 0.05 grams Water vapor & 0.9098739 grams Argon yields 4.185383 & 45.81462 cc respectively after equalizing temperatures.

Sums of the partial volumes must equal the cylinder volume of 50 at TDC.

| Angle | Temp. F | PSIA | Cyl Vol | Steam | Argon |
|---|---|---|---|---|---|
| 90 | 6281.403 | 2961.447 | 50 | 4.1853 SUP | 45.8146 |
| 80 | 5912.367 | 2556.354 | 54.21809 | 4.6300 SUP | 49.5880 |
| 70 | 5050.044 | 1754.167 | 66.77021 | 5.8883 SUP | 60.8818 |
| 60 | 4106.926 | 1084.716 | 87.06635 | 7.8927 SUP | 79.1735 |
| 50 | 3294.834 | 663.436 | 114.1641 | 10.626 SUP | 103.5371 |
| 40 | 2663.506 | 419.4027 | 146.8309 | 13.996 SUP | 132.8349 |
| 30 | 2186.437 | 278.9729 | 183.6271 | 18.161 SUP | 165.4661 |
| 20 | 1825.887 | 195.0003 | 223.0029 | 22.377 SUP | 200.6253 |
| 10 | 1545.998 | 144.5772 | 263.401 | 29.013 SUP | 234.3875 |
| 0 | 1334.585 | 110.1319 | 303.3537 | 31.682 SUP | 271.6711 |
| −10 | 1173.009 | 85.30632 | 341.5625 | 25.712 SUP | 315.8498 |
| −20 | 1050.427 | 69.7062 | 376.9491 | 19.498 SUP | 357.4505 |
| −30 | 956.1718 | 59.6932 | 408.6769 | 15.727 SUP | 392.9495 |
| −40 | 884.814 | 52.40205 | 436.1416 | 13.106 SUP | 423.0352 |
| −50 | 830.8615 | 47.46509 | 458.9399 | 11.402 SUP | 447.5375 |
| −60 | 794.1226 | 44.09988 | 476.8266 | 10.295 SUP | 466.5308 |
| −70 | 768.5775 | 41.89244 | 489.6679 | 9.5812 SUP | 480.0866 |
| −80 | 753.5972 | 40.63806 | 497.4006 | 9.1804 SUP | 488.2202 |
| −90 | 749.0366 | 40.22953 | 499.9999 | 9.0537 SUP | 490.9461 |

Exhaust pressure of the binary mixture is 40.2295 psia at 749.0366 degrees F.
Work done is 778.1189 ft-lbs, Estimated W-9 Horsepower @ 3600 RPM = 9.551 hp
Estimated heat for Argon = 36.6385 BTU/sec and for liquid = 17.0970 BTU/sec
Theoretical Efficiency = 12.5612%

Figures and Illustrations

Listing 4 is a computer printout for 10:1 compression at 1400 deg. F. starting gas temperature.

Argon @ STP=39.948 grams for 22.4 liters

Cp=0.133; Cv=0.075165; gamma=1.769441

T2=10476.78 deg. F. & P2=2764.002 psia; Head Vol. 50 cc; CR=10:1;

free Ambient=300 deg. F.

Argon Pres/Temp compensated mass in grams=.8120207

Thermal energy per power cycle to heat Argon=0.1480163 BTUs

Free feed Water heat=268 BTUs per pound

Thermal energy per power cycle to heat Water=6.332228E-02 BTUs

Mechanical work done to compress the Argon is −758.6626 ft-lbs

Event 2

At ADC, inject 0.05 grams of superheated Water at 704 deg. F. % Mole mass Argon=94.19968% % Mole mass H2O 5.800325%

Since the injected Water is superheated, some flashes to vapor;

Volume 0.05 grams of Saturated vapor at 2732.787 psia=0.3402922 cc So, Argon is further compressed and now occupies only 49.65971 cc

The cylinder pressure however, decreases to 2732.787 psia as a result of all the Water converting to saturated vapor and the carrier gas temperature changes to 10298.16 Equalizing temperatures, the vapor's temperature goes up to meet Argon's decreasing temperature at 6727.823 deg. F.

10:1 Compression of Argon starting @ 1400 deg. F. & 47 psia

Calculating partial volumes of 0.05 grams Water vapor & 0.8120207 grams Argon yields 4.432171 & 45.56783 cc respectively after equalizing temperatures.

Sums of the partial volumes must equal the cylinder volume of 50 at TDC.

| Angle | Temp. F | PSIA | Cyl Vol | Steam | Argon |
|---|---|---|---|---|---|
| 90 | 6727.823 | 2977.473 | 50 | 4.4321 SUP | 45.5678 |
| 80 | 6338.564 | 2570.751 | 54.21809 | 4.9082 SUP | 49.3098 |
| 70 | 5432.52 | 1764.889 | 66.77021 | 6.2589 SUP | 60.5112 |
| 60 | 4438.989 | 1092.14 | 87.06635 | 8.4068 SUP | 78.6595 |
| 50 | 3582.834 | 668.1401 | 114.1641 | 11.363 SUP | 102.8006 |
| 40 | 2915.923 | 422.6461 | 146.8309 | 15.036 SUP | 131.794 |
| 30 | 2400.371 | 281.1099 | 183.6271 | 19.452 SUP | 164.1748 |
| 20 | 2020.208 | 196.4961 | 223.0029 | 23.954 SUP | 199.0484 |
| 10 | 1719.998 | 145.9168 | 263.401 | 31.284 SUP | 232.1168 |
| 0 | 1492.543 | 111.1008 | 303.3537 | 34.328 SUP | 269.025 |
| −10 | 1317.009 | 85.7609 | 341.5625 | 28.119 SUP | 313.4429 |
| −20 | 1182.627 | 69.81921 | 376.9491 | 21.228 SUP | 355.7203 |
| −30 | 1080.743 | 59.76393 | 408.6769 | 17.135 SUP | 391.5417 |
| −40 | 1002.673 | 52.79094 | 436.1416 | 14.416 SUP | 421.7255 |
| −50 | 944.4111 | 47.52547 | 458.9399 | 12.440 SUP | 446.4995 |
| −60 | 902.3192 | 44.14756 | 476.8266 | 11.216 SUP | 465.6096 |
| −70 | 873.3138 | 41.93295 | 489.6679 | 10.429 SUP | 479.238 |
| −80 | 857.5972 | 40.67531 | 497.4006 | 9.9988 SUP | 487.4018 |
| −90 | 851.0366 | 40.26515 | 499.9999 | 9.8487 SUP | 490.1512 |

Exhaust pressure of the binary mixture is 40.2651 psia at 851.0366 degrees F.
Work done is 783.384 ft-lbs; Estimated W-9 Horsepower @ 3600 RPM 12.1361 hp
Estimated heat for Argon = 39.96441 BTU/sec and for liquid = 17.0970 BTU/sec
Theoretical Efficiency = 15.03015%

Figures and Illustrations

Listing 5 is a computer printout for 12:1 compression at 1200 deg. F. starting gas temperature.

Argon @ STP=39.948 grams for 22.4 liters

Cp=133 Cv=0.075165 gamma=1.769441

T2=10770.53 deg. F. & P2=2760.743 psia; Head Vol.=41.6667 cc; CR=12:1;

free Ambient=300 deg. F.

Argon Pres/Temp compensated mass in grams=0.6582066

Thermal energy per power cycle to heat Argon 9.816456E-02 BTUs

Free feed Water heat=268 BTUs per pound

Thermal energy per power cycle to heat Water=4.432559E-02 BTUs

Mechanical work done to compress the Argon is −648.5344 ft-lbs

Event 2

At TDC, inject 0.035 grams of superheated Water at 704 deg. F. % Mole mass Argon=94.951% % Mole mass H2O=5.048999%

Since the injected Water is superheated, some flashes to vapor;

Volume 0.035 grams of Saturated vapor at 2734.399 psia=0.2378876 cc So, Argon is further compressed and now occupies only 41.42878 cc

The cylinder pressure however, decreases to 2734.399 psia as a result of all the Water converting to saturated vapor and the carrier gas temperature changes to 10615.93 Equalizing temperatures, the vapor's temperature goes up to meet Argon's decreasing temperature at 7199.492 deg. F.

12:1 Compression of Argon starting 8 1200 deg. F & 34 psia

Calculating partial volumes of 0.035 grams Water vapor & 0.6582066 grams Argon yields 3.331799 & 38.33487 cc respectively after equalizing temperatures.

Sums of the partial volumes must equal the cylinder volume of 41.6667 at TDC.

| Angle | Temp. F | PSIA | Cyl Vol | Steam | Argon |
|---|---|---|---|---|---|
| 90 | 7199.492 | 2954.399 | 41.66667 | 3.3317 SUP | 38.33487 |
| 80 | 6693.274 | 2474.644 | 45.96288 | 3.7609 SUP | 42.20195 |
| 70 | 5581.69 | 1590.765 | 58.74744 | 4.9866 SUP | 53.76077 |
| 60 | 4434.087 | 923.742 | 79.41944 | 6.9565 SUP | 72.46288 |
| 50 | 3495.073 | 539.0018 | 107.019 | 9.6969 SUP | 97.32202 |
| 40 | 2790.533 | 329.7793 | 140.2907 | 13.082 SUP | 127.2083 |
| 30 | 2267.495 | 214.0209 | 177.7684 | 16.943 SUP | 160.8246 |
| 20 | 1881.981 | 148.6708 | 217.8733 | 23.112 SUP | 194.7608 |
| 10 | 1588.337 | 106.9171 | 259.0196 | 25.766 SUP | 233.2534 |
| 0 | 1365.485 | 78.10737 | 299.7121 | 18.435 SUP | 281.2764 |
| −10 | 1198.119 | 61.58424 | 338.6284 | 13.282 SUP | 325.3464 |
| −20 | 1069.991 | 50.85831 | 374.6704 | 10.164 SUP | 364.5055 |
| −30 | 972.6651 | 43.53189 | 406.9858 | 8.1669 SUP | 398.8188 |
| −40 | 899.26 | 38.05911 | 434.9591 | 6.7535 SUP | 428.2055 |
| −50 | 843.4289 | 34.49232 | 458.1796 | 5.8702 SUP | 452.3094 |
| −60 | 805.2305 | 32.01327 | 476.3975 | 5.2878 SUP | 471.1096 |
| −70 | 778.4795 | 30.39824 | 489.4766 | 4.9135 SUP | 484.5631 |
| −80 | 764.2328 | 29.48538 | 497.3525 | 4.7102 SUP | 492.6423 |
| −90 | 758.4092 | 29.18753 | 499.9999 | 4.6399 SUP | 495.36 |

Exhaust pressure of the binary mixture is 29.1875 psia at 758.4092 degrees F.
Work done is 666.9431 ft-lbs; Estimated W-9 Horsepower @ 3600 RPM = 9.0370 hp
Estimated heat for Argon = 26.50443 BTU/sec
Estimated heat for injected liquid = 11.96791 BTU/sec
Theoretical Efficiency = 16.59994%

Figures and Illustrations

Listing 6 is a computer printout for 12:1 compression at 1400 deg. F. starting gas temperature.

Argon @ STP=39.948 grams for 22.4 liters

Cp=133 Cv=0.075165 gamma=1.769441

T2=12123.84 deg. F. & P2=2760.743 psia; Head Vol.=41.6667 cc; CR =12:1;

free Ambient=300 deg. F.

Argon Pres/Temp compensated mass in grams=0.5874192

Thermal energy per power cycle to heat Argon=0.1070757 BTUs

Free feed Water heat=268 BTUs per pound

Thermal energy per power cycle to heat Water=4.432559E-02 BTUs

Mechanical work done to compress the Argon is −648.5344 ft-lbs

Event 2

At ADC, inject 0.035 grams of superheated Water at 704 deg. F. % Mole mass Argon=94.37678% % Mole mass H2O=5.62322%

Since the injected Water is superheated, some flashes to vapor;

Volume 0.035 grams of Saturated vapor at 2734.399 psia=0.2378876cc So, Argon is further compressed and now occupies only 41.42878 cc

The cylinder pressure however, decreases to 2734.399 psia as a result of all the Water converting to saturated vapor and the carrier gas temperature changes to 11950.6 Equalizing temperatures, the vapor's temperature goes up to meet Argon's decreasing temperature at 7714.418 deg. F.

12:1 Compression of Argon starting @ 1400 deg. F. & 34 psia

Calculating partial volumes of 0.035 grams Water vapor & 0.5874192 grams Argon yields 3.532375 & 38.13429 cc respectively after equalizing temperatures.

Sums of the partial volumes must equal the cylinder volume of 41.6667 at TDC.

| Angle | Temp. F | PSIA | Cyl Vol | Steam | Argon |
|---|---|---|---|---|---|
| 90 | 7714.418 | 2969.924 | 41.66667 | 3.5323 SUP | 38.1342 |
| 80 | 7173.274 | 2488.044 | 45.96288 | 3.9886 SUP | 41.9742 |
| 70 | 6005.69 | 1600.18 | 58.74744 | 5.3040 SUP | 53.4433 |
| 60 | 4794.087 | 929.7141 | 79.41944 | 7.4253 SUP | 71.9941 |
| 50 | 3802.525 | 542.8007 | 107.019 | 10.385 SUP | 96.6333 |
| 40 | 3053.34 | 332.2596 | 140.2907 | 14.051 SUP | 126.2389 |
| 30 | 2489.76 | 215.678 | 177.7684 | 18.227 SUP | 159.541 |
| 20 | 2079.981 | 149.9546 | 217.8733 | 24.869 SUP | 193.0038 |
| 10 | 1766.371 | 107.7979 | 259.0196 | 27.897 SUP | 231.1217 |
| 0 | 1527.485 | 78.36844 | 299.7121 | 20.123 SUP | 279.5889 |
| −10 | 1344.46 | 61.65889 | 338.6284 | 14.465 SUP | 324.1626 |
| −20 | 1205.932 | 50.90034 | 374.6704 | 11.079 SUP | 363.5905 |
| −30 | 1098.773 | 43.55795 | 406.9858 | 8.8979 SUP | 398.0878 |
| −40 | 1019.412 | 38.42031 | 434.9591 | 7.4608 SUP | 427.4982 |
| −50 | 959.3326 | 34.51474 | 458.1796 | 6.4075 SUP | 451.7721 |
| −60 | 915.2305 | 32.03089 | 476.3975 | 5.7622 SUP | 470.6352 |
| −70 | 886.4795 | 30.41343 | 489.4766 | 5.3566 SUP | 484.12 |
| −80 | 868.9189 | 29.49901 | 497.3525 | 5.1273 SUP | 492.2252 |
| −90 | 864.4092 | 29.20099 | 499.9999 | 5.0581 SUP | 494.9417 |

Exhaust pressure of the binary mixture is 29.2010 psia at 864.4092 degrees F.
Work done is 671.0901 ft-lbs, Estimated W-9 Horsepower @ 3600 RPM = 11.073 hp
Estimated heat for Argon = 28.9104 BTU/sec and for liquid = 11.9679 BTU/sec
Theoretical Efficiency = 19.14237%

Conclusion

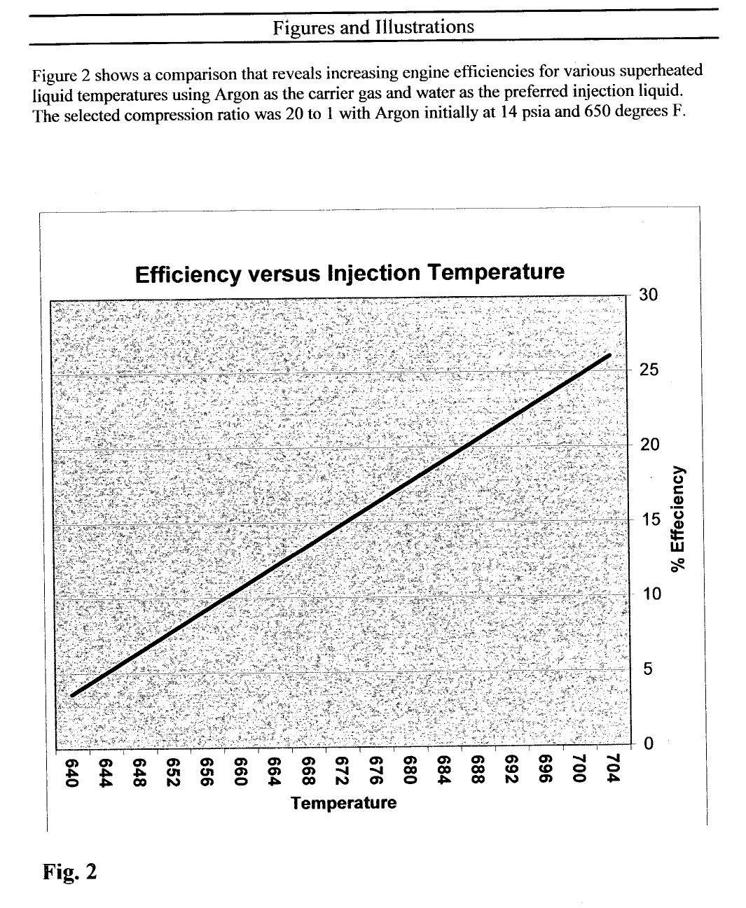

The enclosed figures show that efficiency increases with increasing compression and increasing temperatures as would be expected but power seems to decrease. Increasing the temperature of the injected liquid produces a nearly linear increase in efficiency as shown by FIG. 2. Aditional data on super critical liquid injection temperatures and pressures should yield further increases.

The present invention makes it possible to develop an externally heated non-polluting engine. The cycle can use a preheated supply of liquid for direct injection. In an automotive application, the liquid can be heated prior to getting onto the road. The carrier gas may be straight air or cheaper, throw-away gasses like Oxygen, Nitrogen, or possibly even Argon for use in an open thermodynamic cycle. The carrier gas may also be more expensive gasses that are contained within a closed thermodynamic cycle. Using oxygen as the carrier gas, it may show a practical, high efficiency application for a boron/oxygen type engine. Using the boron/oxygen as a recyclable heat source creates a pollution free heat source for automotive power applications. The combustion products are Hot Oxygen and Boron oxide which is a glassy solid. Any pollution free or reduced emissions heating source is good for automotive applications because certain pollutants are hard to eliminate in internal combustion engines. Using a high quality molecular sieve to separate pure oxygen from the air may become more practical with moderate technological advances.

The ability to add a bottoming cycle to the superheated steam and gas mixture leaving a RAKH CYCLE engine as exhaust may allow for further gains of efficiency. This thermodynamic cycle actually creates a physical phase change diode, similar to the electrical diode. The phase change takes place due to concentration of heat manifested as a temperature increase. The phase change in the cycle occurs without a boiler. The compressed volume of the carrier gas is better than a boiler since the heat in a boiler has to pass through a heat exchanger. In this cycle, direct contact with the heat source causes a rapid, nearly explosive, phase change.

Using Helium as the carrier gas may allow easy molecular separation of the liquid from the carrier gas without condensing the liquid. The benefit of that ability would be a selective application of condenser cooling to the liquid without having to remove heat from the carrier gas. All of the noble gasses, being inert, are easier to heat without worry of corrosion from the gas. They also have an ultra-flat gamma value across a very wide range of temperatures.

Some combinations of carrier gasses and injected liquids do not exhibit an increase of pressure as the heat of the carrier gas is used to vaporize the injected liquid. The corresponding loss of temperature coincides with a corresponding decrease in the pressure. This pressure drop takes an overall input of work to enable continued operation rather than producing work as an engine must if is to be called an engine. An optimal gas and liquid pairing for an excellent operational engine would necessarily utilize only a small drop in temperature of the carrier gas in order to vaporize the liquid with a resulting large increase in pressure from a small amount of latent heat added. Not much experimentation has been done in the effort of finding substances to present a thermodynamic RAKH CYCLE with optimal conditions for producing power and efficiency. It works, but much must be done to justify its use over other thermodynamic cycles in terms of cost benefit for such a pollution free yet low power engine albeit one with such reasonable efficiency. Oerating temperatures and pressures will provide significant technological challenges as well.

I claim:

1. A thermodynamic engine power cycle that uses a carrier gas, which is compressed to increase its temperature so that a superheated liquid may be injected into the hot carrier gas and result in pressure increase to generate power from a portion of the heat input via the gas and the liquid. Over-pressurized, superheated liquid is injected and mixes with a hotter carrier gas at a pressure below the saturation pressure corresponding to the temperature of the liquid, causing full or partial liquid vaporization that results in a net increase in pressure upon equalization of temperatures for the mixture. The increase of pressure is then extracted as work during adiabatic expansion of the mixture. Engine power is very dependent upon selection of the proper working carrier gas and injected liquid at effective temperatures and pressures, which are compatible with an increase of pressure for the mixture. This invention covers the identified thermodynamic engine cycle using any gasses and liquids, which exhibit an increase of pressure with the necessary incidental decrease in carrier gas temperature due to transfer of thermal energy to the injected liquid in the mixture. Combustion of the carrier gas and/or the injected liquid is not a required heat source for an engine that is covered by the present invention .

2. A thermodynamic refrigeration cycle, which uses any said real carrier gas that is compressed to concentrate thermal energy during a compression event that increase the temperature of the carrier gas and achieves rapid cooling upon injection of a liquid substance that takes up part of the heat of the carrier gas in vaporizing some or all of the injected liquid. The temperature of the mixture at an end pressure achieved during adiabatic expansion of the mixture is lower than the initial temperature of the carrier gas.

3. This thermodynamic cycle is covered with arbitrary selection of any cycle event of the said RAKH cycle as the first event with the rest of the events in the same relative cyclical sequence. Combining or adding events in the cycle are covered as long as the essence the cycle relies on transfer of concentrated thermal energy in the form of increased temperature due to compression of a carrier gas and subsequent transfer of a portion of that thermal energy to an injected substance, which increases overall pressure of the mixture after equalization of their temperatures.

4. A thermodynamic cycle is covered by the scope of this invention even if the substance injected is pressurized above the critical pressure of the liquid phase of that substance.

5. A thermodynamic cycle is covered by the scope of this invention even if the substance injected into the compressed volume of the carrier gas is injected at a temperature above the critical temperature for the liquid phase of that substance.

6. A two stroke or four stroke or any other superficial mechanical implementation or even turbines engines are covered in this thermodynamic cycle as well as is any other means of generating the cycle mechanically, including turbocharging or supercharging the carrier gas.

7. Other patent claims may restrict and protect use of certain patented, or yet to be patented substances, which may optimize certain characteristics of the carrier gas or the injected liquids but will still constitute no more than just a specific implementation of this RAKH Cycle when used within the thermodynamic cycle described under the present invention.
